(19) United States
(12) Patent Application Publication
(10) Pub. No.: US 2019/0308351 A1
(43) Pub. Date: Oct. 10, 2019

(54) SYNTHETIC RESIN THRUST PLATE AND METHOD FOR MANUFACTURING THE SAME

(71) Applicant: NTN CORPORATION, Osaka (JP)

(72) Inventors: Satoru FUKUZAWA, Mie (JP); Hirohisa ABE, Mie (JP)

(73) Assignee: NTN CORPORATION, Osaka (JP)

(21) Appl. No.: 16/466,636

(22) PCT Filed: Nov. 24, 2017
(86) PCT No.: PCT/JP2017/042135

§ 371 Date: Jun. 4, 2019

(30) Foreign Application Priority Data
Dec. 8, 2016 (JP) 2016-238508
Sep. 7, 2017 (JP) 2017-172200

(51) Int. Cl. B29C 45/38; F16C 17/04; F16H 1/28; F16H 57/08

(52) U.S. Cl. CPC B29C 45/38; F16C 17/04; F16C 33/10; F16H 57/08; F16H 1/28

(57) ABSTRACT

To provide a synthetic resin thrust plate having usable plane accuracy while eliminating correction of the plane shape thereof with a hot-plate press and a method for manufacturing the same. A synthetic resin thrust plate 1 is a hollow disc-shaped, synthetic resin thrust plate having a plurality of radial grooves 2 and 3 at equiangular intervals in terms of a disc central angle on both thrust faces 1a and 1b, respectively. The grooves 2 on one thrust face 1a and the grooves 3 on another thrust face 1b are the same in number. The grooves 2 on the one thrust face 1a and the grooves 3 on the other thrust face 1b are arranged so as not to overlap with each other in a circumferential direction. In particular, the grooves 2 on the one thrust face 1a and the grooves 3 on the other thrust face 1b are arranged in a staggered manner so as to have an angular deviation of ½ of an angular interval between the grooves adjacent to each other on the same thrust face in terms of the disc central angle.

### TECHNICAL FIELD

The present invention relates to a hollow disc-shaped, synthetic resin thrust plate and a method for manufacturing the same and relates in particular to a synthetic resin thrust plate that can be used for a planetary gear device and a method for manufacturing the same.

### BACKGROUND ART

A planetary gear device is used as a reduction mechanism in travel devices, swing devices, rope winches for hydraulic cranes, and the like of hydraulic shovels, hydraulic cranes, and the like as construction machinery. The planetary gear device has a structure in which a plurality of planetary gears revolve around a sun gear while rotating on their axes. The planetary gears are gears that are arranged between the sun gear and a ring gear and mesh with them and are rotatably supported on the carrier via planetary gear shafts. The carrier is an annular member picking up the revolution of the planetary gears around the sun gear, supports a drive shaft of the sun gear at substantially its center, and supports the planetary gear shafts at substantially equal intervals on the outer circumferential side of the annulus. In such a structure, a thrust plate is interposed between an end face of the planetary gear and a bearing face of the carrier. This thrust plate is a hollow disc-shaped sliding member and is provided in order to reduce wear through sliding contact between the planetary gear and the carrier.

When the planetary gear rotates, this thrust plate relatively rotates with respect to not only the end face of the planetary gear but also the bearing face of the carrier. For this reason, the edge of the bearing face of the carrier may possibly wear depending on the extent of the relative rotation. To prevent this wear, a structure that prevents the relative rotation of the thrust plate with respect to the carrier can be employed. This structure, however, may fail to prevent wear in the planetary gear, while successfully preventing wear in the carrier. Patent Literature 1 presents as a thrust plate to prevent this problem, for example. This thrust plate has dot-shaped or linearly extending protrusions on the same circumference of a plate face and is capable of moderately relatively rotating with respect to both the planetary gear and the carrier.

### PRIOR ART DOCUMENT

### Patent Document

Patent Literature 1: JP 2008-256069 A

### SUMMARY OF THE INVENTION

### Problems to be Solved by the Invention

Synthetic resin thrust plates have been conventionally known as this kind of thrust plate. For synthetic resin thrust plates, injection-molded products are being used. However, the thrust plate is shaped like a thin disc, and when it is molded to be thin by injection molding, strain (curving) occurs in the plane shape thereof, and thus the thrust plate is difficult to use as it is and is subjected to correction of the plane shape thereof with a hot-plate press after injection molding. Given these circumstances, the production time is prolonged, making a cost reduction difficult. When a thrust plate having an outer diameter of greater than 70 mm is manufactured by injection molding in particular, strain is likely to occur on the planes thereof, which makes correction of the plane shape thereof with a hot-plate press essential.

The present invention has been made in order to cope with the above problems, and an object thereof is to provide a synthetic resin thrust plate having usable plane accuracy while eliminating correction of the plane shape thereof with a hot-plate press and a method for manufacturing the same. In particular, an object thereof is to provide a synthetic resin thrust plate and a method for manufacturing the same that can eliminate the correction even for a thrust plate having an outer diameter of greater than 70 mm and a method for manufacturing the same.

### Means for Solving the Problem

A synthetic resin thrust plate according to the present invention is a hollow disc-shaped, synthetic resin thrust plate, the thrust plate having a plurality of radial grooves at equiangular intervals in terms of a disc central angle on each of both thrust faces, in which the grooves on one thrust face and the grooves on another thrust face are the same in number, and the grooves on the one thrust face and the grooves on the other thrust face are arranged so as not to overlap with each other in a circumferential direction.

In particular, the grooves on the one thrust face and the grooves on the other thrust face are arranged so as to have an angular deviation of ½ of an angular interval between the grooves adjacent to each other on the same thrust face in terms of the disc central angle.

The thrust plate is an injection-molded product and has skin layers by injection molding on both thrust faces.

The synthetic resin is at least one selected from polyamide (PA) resin, polyacetal (POM) resin, polyphenylene sulfide (PPS) resin, polyether ether ketone (PEEK) resin, and polyimide (PI) resin.

The thrust plate has a thickness of 1 mm to 5 mm and an outer diameter of greater than 70 mm.

The thrust plate is used for a planetary gear device, is arranged between a planetary gear and a carrier included in the device such that the one thrust face is in contact with the planetary gear and the other thrust face is in contact with the carrier, and has a hollow part into which a planetary gear shaft inserted when used. In particular, the planetary gear device is a planetary gear device used for construction machinery.

A method for manufacturing a synthetic resin thrust plate according to the present invention is a manufacturing method manufacturing the synthetic resin thrust plate according to the present invention by injection molding, in which the thrust plate has a thickness of 1 mm to 5 mm and an outer diameter of greater than 70 mm, and three or more gates in the injection molding are disposed on the thrust plate at equal intervals in a circumferential direction of the thrust plate, and the synthetic resin is charged through the gates.

The gates are disposed on an inner circumferential face of the thrust plate.

The number of the gates is the same as the number of the grooves on the one thrust face and the number of the grooves on the other thrust face, and the gates are provided so as not to overlap with the grooves on the one thrust face and the grooves on the other thrust face in the circumferential direction.

### Effects of the Invention

The synthetic resin thrust plate (hereinafter also simply referred to as “thrust plate”) according to the present invention is a hollow disc-shaped, synthetic resin thrust plate, the thrust plate having a plurality of radial grooves at equiangular intervals in terms of a disc central angle on each of both thrust faces, in which the grooves on one thrust face and the grooves on another thrust face are the same in number, and the grooves on the one thrust face and the grooves on the other thrust face are arranged so as not to overlap with each other in a circumferential direction. Thus, strain on the planes is relaxed by the grooves on the one thrust face and the grooves on the other thrust face, and a usable state can be maintained even after being injection-molded. This can eliminate correction of the shape thereof with a hot-plate press. In particular, the grooves on the one thrust face and the grooves on the other thrust face are arranged so as to have an angular deviation of ½ of an angular interval between the grooves adjacent to each other on the same thrust face in terms of the disc central angle, so that the strain on the planes can be further relaxed.

The thrust plate is an injection-molded product and has skin layers by injection molding on both thrust faces. Therefore, even when the synthetic resin is blended with reinforcing members such as glass fibers, the reinforcing members do not appear on the surface thereof, and an opposite member can be prevented from being damaged.

Since the synthetic resin as a material is at least one selected from PA resin, POM resin, PPS resin, PEEK resin, and PI resin, a thrust plate excellent in heat resistance, mechanical strength, and friction and wear characteristics can be obtained.

The thrust plate according to the present invention can sufficiently relax the strain on the planes owing to the above structure and can eliminate correction of the shape thereof with a hot-plate press after injection molding even with a thickness of 1 mm to 5 mm and a size with an outer diameter of greater than 70 mm.

The thrust plate according to the present invention can be suitably used as a thrust plate that is used for a planetary gear device, is arranged between a planetary gear and a carrier included in the device such that the one thrust face is in contact with the planetary gear and the other thrust face is in contact with the carrier, and has a hollow part into which a planetary gear shaft inserted when used. In particular, the thrust plate according to the present invention can be suitably used as a thrust plate in a planetary gear device used for construction machinery such as travel devices, swing devices, and rope winches for hydraulic cranes of hydraulic shovels, hydraulic cranes, and the like.

The method for manufacturing a synthetic resin thrust plate according to the present invention is a manufacturing method manufacturing the synthetic resin thrust plate by injection molding, in which the thrust plate has a thickness of 1 mm to 5 mm and an outer diameter of greater than 70 mm, and three or more gates in the injection molding are disposed on the thrust plate, which can reduce the charging time and thus reduce the production time. In addition, these gates are provided at equal intervals in the circumferential direction of the thrust plate, and the synthetic resin is charged through the gates. Consequently, the synthetic resin can be uniformly charged, and variations in the amount of the synthetic resin on the planes can be reduced. This can relax the strain on the planes and maintain a usable state even after being injection-molded. Consequently, correction of the shape thereof with a hot-plate press can be eliminated. In this case, even for a large-sized thrust plate, in which the strain on the planes is particularly conspicuous, such as a thrust plate having an outer diameter of greater than 90 mm, four gates are provided at equal intervals in the circumferential direction of the thrust plate, for example, whereby the strain on the planes can be sufficiently relaxed, and correction of the shape thereof with a hot-plate press can be eliminated.

The gates are disposed on an inner circumferential face of the thrust plate, and thus gate marks are formed on the inner circumferential face of the thrust plate. Consequently, the gate marks do not interfere with sliding. In addition, the moving distance of the resin is shorter than that in a case in which the gates are disposed on an outer circumferential face of the thrust plate, and the resin is not easily cooled. Consequently, the resin has excellent flowability, and the strain on the planes can be further relaxed. In addition, the amount of the synthetic resin used can be reduced.

The number of the gates is the same as the number of the grooves on the one thrust face and the number of the grooves on the other thrust face, and the gates are provided so as not to overlap with the grooves on the one thrust face and the grooves on the other thrust face in the circumferential direction. As a result, a weld, which is formed at an area in which a molten resin merges, does not overlap with the grooves on both thrust faces, and a reduction in the strength of the thrust plate can be prevented.

### BRIEF DESCRIPTION OF THE DRAWINGS

FIG. 1 is a perspective view of an example a thrust plate according to the present invention.

FIG. 2 includes a plan view and a sectional view of the thrust plate in FIG. 1.

FIG. 3 includes a plane view and the like of another example of the thrust plate according to the present invention.

FIG. 4 includes diagrams of sectional shapes of a groove.

FIG. 5 includes schematic diagrams of a method for manufacturing the thrust plate in FIG. 1.

FIG. 6 is a diagram of a mode of a groove and a gate position.

FIG. 7 is a perspective view of another example of a thrust plate by the present manufacturing method.

FIG. 8 is a schematic diagram of a method for manufacturing the thrust plate in FIG. 7.

FIG. 9 is a schematic diagram of another method for manufacturing the thrust plate in FIG. 7.

FIG. 10 is a sectional view of an example of a planetary gear mechanism.

### MODE FOR CARRYING OUT THE INVENTION

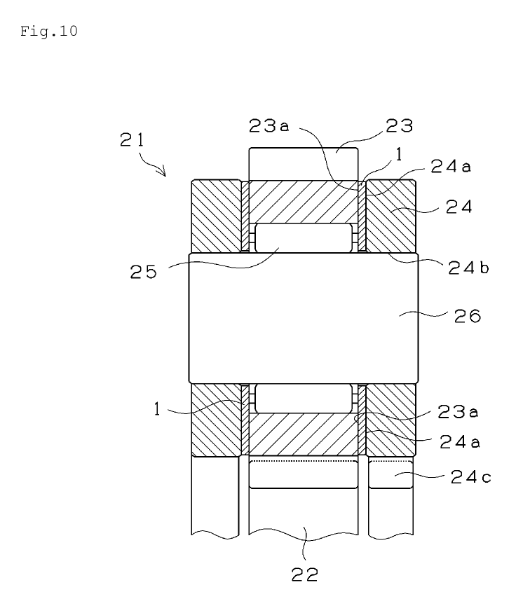

The following describes an example of a planetary gear device in which a synthetic resin thrust plate according to the present invention is used based on FIG. 10. FIG. 10 is a sectional view of a planetary gear device used for a travel device of construction machinery illustrating the vicinity of its planetary gear. As illustrated in FIG. 10, this planetary gear device 21 includes a sun gear 22, a plurality of planetary gears 23, a carrier 24 supporting these planetary gears 23, and a ring gear (not illustrated) The planetary gears 23 are arranged between the sun gear 22 and the ring gear and mesh with them. The carrier 24 is an annular member supporting the planetary gears 23 and supports the planetary gears 23 at substantially equal intervals on the outer circumferential side of the annulus.

A planetary gear shaft 26 of the planetary gear 23 is inserted into a shaft hole 24b of the carrier 24 and is supported rotatably via a needle bearing 25. The carrier 24 supports drive shafts of the planetary gears 23 at substantially its center. In this structure, the planetary gears 23 revolve around the sun gear 22 between the sun gear 22 and the ring gear while being supported on the carrier 24 to rotate on their axes.

A thrust plate 1 is interposed between an end face 23a of the planetary gear 23 and a bearing face 24a of the carrier 24. This thrust plate 1 is the synthetic resin thrust plate according to the present invention. One thrust face of the thrust plate 1 and another thrust face thereof are in contact with the end face 23a of the planetary gear 23 and the bearing face 24a of the carrier 24, respectively. The planetary gear shaft 26 is inserted into a hollow part of the thrust plate 1. This thrust plate 1 can prevent wear caused by direct sliding contact between the planetary gear 23 and the carrier 24.

The planetary gear device 21 is subjected to bath lubrication, for example. When this planetary gear device 21 is driven, as described above, the planetary gears 23 supported on the carrier 24 revolve around the sun gear 22 while rotating on their axes. During bath lubrication, the planetary gears 23 get in and out of lubricating oil in an oil tank. When they are immersed into the oil, the oil flows into the planetary gear device 21 through an oil hole or the like provided in the planetary gear shaft 26. With this oil flow, the lubricating oil is supplied to the needle bearing 25 of the planetary gear 23 and plane parts as sliding contact faces of the thrust plate 1.

The thickness of the thrust plate 1 according to the present invention is 1 mm to 5 mm, and the inner diameter and the outer diameter thereof are (inner diameter: outer diameter)=(25 mm: 45 mm) to (120 mm: 200 m). When a thrust plate having an outer diameter of greater than 70 mm is manufactured by injection molding in particular, strain is likely to occur on the planes (thrust faces). Planetary gear devices used for construction machinery are relatively large in size, in which thrust plates having an outer diameter of greater than 70 mm are employed. By employing the present invention, even such thrust plates having an outer diameter of greater than 70 mm can be manufactured with high plane accuracy simply by injection molding without correction of the shape of the thrust faces with a hot-plate press. In thrust plates having an outer diameter of smaller than 70 mm, the strain on the planes is not likely to occur, yet employing the present invention gives higher plane accuracy.

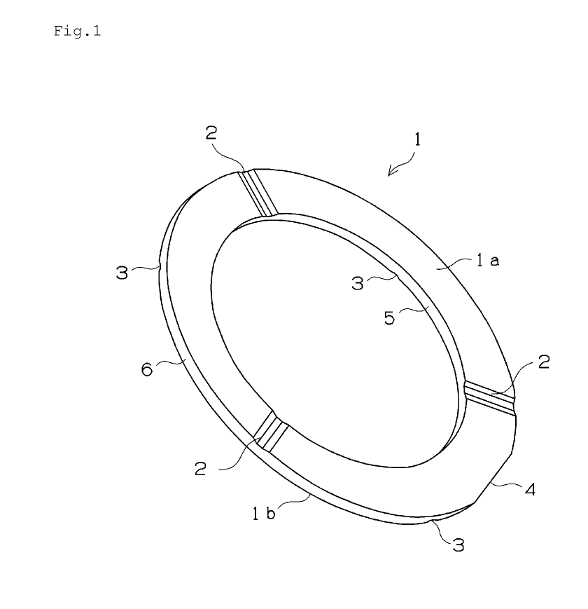

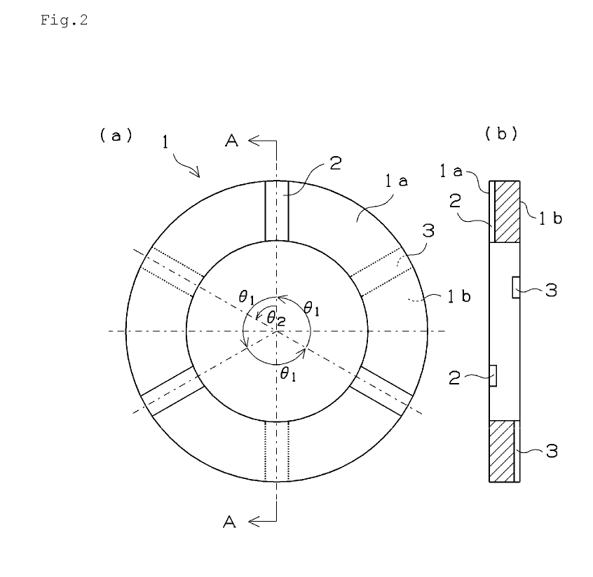

The following describes one embodiment of the synthetic resin thrust plate according to the present invention based on FIG. 1 and FIG. 2. FIG. 1 is a perspective view of the thrust plate. FIG. 2(a) is a front view of the thrust plate in FIG. 1, and FIG. 2(b) is an A-A line sectional view thereof. As illustrated in FIG. 1, the thrust plate 1 of this form is a hollow disc-shaped (an annular plate-shaped) member, in which a thrust face 1a and a thrust face 1b as the opposite face thereof have a plane shape. The thrust plate 1 has an inner circumferential face 5 connecting both thrust faces 1a and 1b together on its inner radial side and an outer circumferential face 6 connecting both thrust faces 1a and 1b together on its outer radial side. The thrust plate 1 is a synthetic resin molded-product and is manufactured into the shape by injection molding with an injection moldable synthetic resin as a material. The thrust plate 1 has a detent 4 formed by cutting off part of the outer circumference of the disc. This detent 4 is engaged with part of a carrier (refer to FIG. 10), whereby the relative rotation of the thrust plate 1 with respect to the carrier can be prevented. The thrust plate 1 has three radial grooves 2 and three radial grooves 3 on both thrust faces. These radial grooves 2 and 3 are formed as recesses passing through from the inner circumference to the outer circumference of the disc on each of the thrust faces. When the planetary gear device is driven, these grooves function as lubricating grooves, and the supplying performance of the lubricating oil to the plane parts improves compared with a case in which no groove is formed.

As illustrated in FIG. 1 and FIG. 2, the grooves 2 on the one thrust face 1a and the grooves 3 on the other thrust faces 1b are the same in number (three). On the thrust face 1a, the three grooves 2 are provided at equiangular intervals in terms of a disc central angle. That is, an angular interval θ₁ between adjacent grooves is 120°. The positions of the grooves are the positions of lines passing from the disc center through the substantially circumferentially center of the grooves. Also on the thrust face 1b similarly, the three grooves 3 are provided at equiangular intervals (every 120°) in terms of the disc central angle. In the thrust plate 1 according to the present invention, in such a configuration, the grooves 2 on the thrust face 1a and the grooves 3 on the thrust face 1b are arranged in a staggered manner between the back and front thrust faces such that they do not overlap with each other in the circumferential direction of the disc. With this configuration, strain on the planes (the thrust faces 1a and 1b) is relaxed by the grooves 2 on the thrust face 1a and the grooves 3 on the thrust face 1b, and a usable state can be maintained even after being injection-molded. This can eliminate correction of the shape of the thrust faces with a hot-plate press. The grooves do not overlap with each other, whereby the strength of the thrust plate is prevented from extremely reducing.

In the example illustrated in FIG. 2, the grooves 2 on the thrust face 1a and the grooves 3 on the thrust face 1b are arranged so as to have a deviation of 60° in terms of the disc central angle. The grooves 2 on the thrust face 1a and the grooves 3 on the thrust face 1b are arranged in a staggered manner between the back and front thrust faces and have an adjacent angular interval θ₂ of 60° when they are viewed from immediately above the disc. That is, they are arranged so as to have an angular deviation of ½ of the angular interval (120°) between the grooves adjacent to each other on the same thrust face. With this configuration, the grooves on the other thrust face are arranged at the circumferential center between the grooves on the one thrust face. With this configuration, the strain on the planes (the thrust faces 1a and 1b) is further relaxed. In addition, a reduction in the strength of the thrust plate caused by the formation of the grooves is prevented. Consequently, even a thrust plate having a larger outer diameter such as an outer diameter of greater than 70 mm can be manufactured with high plane accuracy simply by injection molding without correction of the shape of the thrust faces with a hot-plate press.

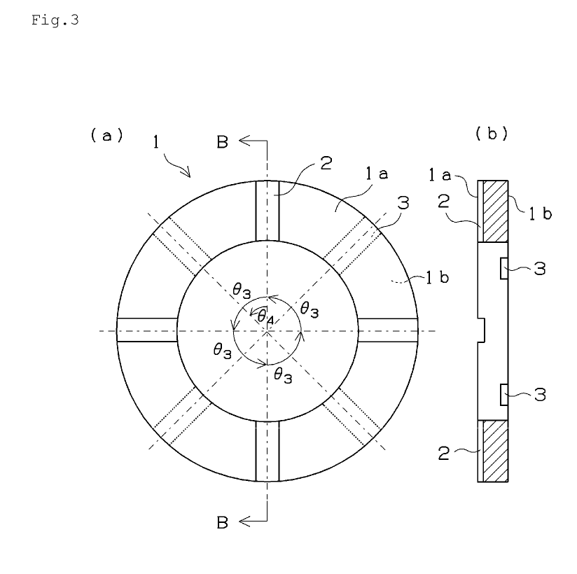

The following describes another embodiment of the synthetic resin thrust plate according to the present invention based on FIG. 3. FIG. 3(a) is a front view of the thrust plate, and FIG. 3(b) is a B-B line sectional view thereof. As illustrated in FIG. 3, the thrust plate 1 of this form is similar to the thrust plate in FIG. 1 except the number and arrangement of the grooves. The thrust plate 1 has four radial groves 2 and four radial grooves 3 on both thrust faces. As illustrated in FIG. 3, the grooves 2 on the one thrust face 1a and the grooves 3 on the other thrust face 1b are the same in number (four). On the thrust face 1a, the four grooves 2 are provided at equiangular intervals in terms of the disc central angle. That is, an angular interval θ₃ between the adjacent grooves is 90°. Also on the thrust face 1b similarly, the four grooves 3 are provided at equiangular intervals (every 900) in terms of the disc central angle. In this configuration, the grooves 2 on the thrust face 1a and the grooves 3 on the thrust face 1b are arranged in a staggered manner between the back and front thrust faces such that they do not overlap with each other in the circumferential direction of the disc.

In the example illustrated in FIG. 3, the grooves 2 on the thrust face 1a and the grooves 3 on the thrust face 1b are arranged so as to have a deviation of 45° in terms of the disc central angle. The grooves 2 on the thrust face 1a and the grooves 3 on the thrust face 1b are arranged in a staggered manner between the back and front thrust faces and have an adjacent angular interval θ₄ of 45° when they are viewed from immediately above the disc. With this configuration, in a similar manner to the case in FIG. 2, the grooves on the other thrust face are arranged at the circumferential center between the grooves on the one thrust face, and the strain on the planes (the thrust faces 1a and 1b) is relaxed by the grooves 2 on the thrust face 1a and the grooves 3 on the thrust face 1b, thus producing an effect similar to that of the case in FIG. 2.

In the present invention, although the number of the grooves on one thrust face is not limited to FIG. 2 (three) and FIG. 3 (four), it is preferably three or more. In any number, both faces have the same number of grooves. The number of the grooves is up to eight. The reason why the number of the grooves is at least three (FIG. 2) is that two grooves do not sufficiently eliminate the strain on the planes. The reason why the number of the grooves is up to eight is that a larger area of the grooves reduces a sliding area and increases surface pressure. The number of the grooves is more preferably three to six and most preferably is four on one face illustrated in FIG. 3.

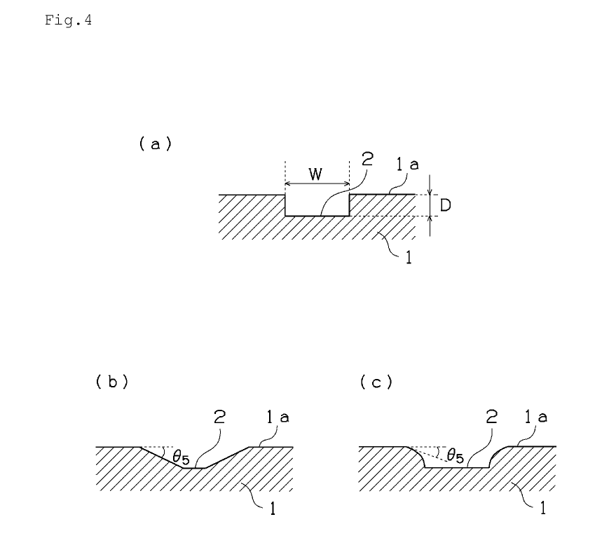

The following describes the shape of the grooves based on FIG. 4. Although FIG. 4 illustrates the groove 2 on the thrust face 1a, the same holds true for the groove 3 on the thrust face 1b. A groove depth D is preferably set to a range of 6/100 to 4/10 of the thickness of the thrust plate. However, when the thickness of the thrust plate is 1 mm to 2 mm, the thinnest part of the thrust plate is required to surely have 0.7 mm or greater. For the thrust plate having a thickness of 2 mm or greater, the groove depth is required to surely have 0.5 mm or greater. In any case out of this range, it is difficult to remove the strain on the planes of the thrust plate. The groove depth D is a depth from a thrust face (the thrust face 1a in FIG. 4) to a groove bottom part and is a depth to the deepest part when the groove bottom is an inclined face or the like.

A groove width W is preferably set to a range of 1/20 to 1/10 of the outer diameter dimension of the thrust plate. Specifically, the groove width W is preferably set to 4 mm to 15 mm. In the radial sectional shape of the groove, an edge part between the thrust face 1a as the plane part and the groove 2 is preferably formed in a taper (FIG. 4(b)) or a curved face (FIG. 4(c)). With this shape, supply of the lubricating oil to the plane part can be smoothly performed. The groove width W when the sectional shape of the groove is a taper or a curved face is a width including this tapered part and curved face part. An angle θ₅ of the taper or the curved face relative to the thrust face is preferably 300 or smaller because of excellent dischargeability of the lubricating oil.

In the grooves, all of them are preferably formed in the same width, the same depth, and the same groove sectional shape uniformly from the inner circumference to the outer circumference of the disc. The cases in FIG. 2 and FIG. 3 have such a shape. The grooves are arranged at equal intervals in a staggered manner between the back and front thrust faces and are all formed in the same shape, whereby the strain on the planes is further relaxed.

For the synthetic resin forming the thrust plate according to the present invention, any synthetic resin can be used so long as it is a synthetic resin being capable of being injection-molded and having heat resistance at a use temperature or higher. Examples thereof include PA resin, POM resin, PPS resin, PEEK resin, PI resin, polyamide-imide resin, and phenol resin. Heat resistance at 80° C. or higher is required for a thrust plate that is arranged between a planetary gear and a carrier of a planetary gear device used for travel devices, swing devices, rope winches for hydraulic cranes, and the like of hydraulic shovels, hydraulic cranes, and the like and is used with a planetary gear shaft inserted. The above-exemplified resins can be suitably used for this use. In addition, the resins are also excellent in handleability during injection molding. This synthetic resin may be blended with fibrous reinforcing members such as glass fibers, carbon fibers, and aromatic polyamide fibers and inorganic fillers such as silica, calcium carbonate, mica, talc, and wollastonite as needed.

The following describes a method for manufacturing the synthetic resin thrust plate according to the present invention. The thrust plate described above is a synthetic resin injection-molded product and is manufactured by injection molding. In injection molding, two molds (molds for injection molding) relatively moving in an axial direction are used, and the synthetic resin is charged into a cavity formed in these molds through gates.

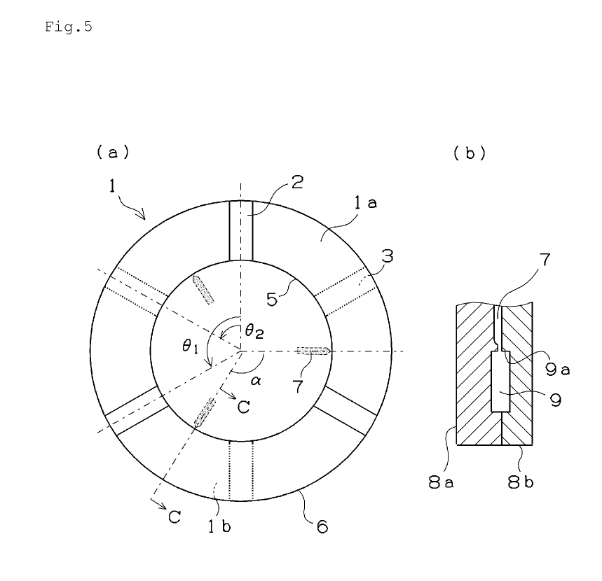

FIG. 5 is a schematic diagram of an example of a method for manufacturing the thrust plate 1 in FIG. 1. FIG. 5(a) illustrates the positions of the gates in a plan view of the thrust plate 1, and FIG. 5(b) illustrates an axial sectional view (a C-C line sectional view) of the molds and one of the gates at a gate position during injection molding. As illustrated in FIG. 5(b), a mold 8 has a fixed mold 8b and a movable mold 8a capable of clamping and opening relative to the fixed mold 8b, in which they are abutted to each other to form a cavity 9 for the thrust plate 1. Although FIG. 5(b) illustrates a partial sectional view, the cavity 9 is formed annularly along the shape of the thrust plate 1. As illustrated in FIG. 5(b), the gate 7 is disposed on a cavity face 9a forming the inner circumferential face 5 of the thrust plate 1. The other gates 7 are provided similarly. That is, the gates 7 are disposed on the cavity face corresponding to the inner circumferential face 5 of the thrust plate 1. The gates 7 are provided at substantially the center of the axial length of the cavity face 9a, for example.

A molten resin is injected from the gates 7, and the resin is charged into the cavity 9. After the resin is charged, dwelling is performed until gate sealing, then the molten resin is solidified by cooling for a certain time, and the movable mold 8a is opened to obtain a synthetic resin thrust plate.

In the manufacturing method according to the present invention, the molten resin is charged through three or more gates arranged at equal intervals in the circumferential direction of the thrust plate. In the example illustrated in FIG. 5, three gates 7 are disposed on the inner circumferential face 5 of the thrust plate 1. These three gates 7 are arranged at equal intervals (uniformly) in the circumferential direction. In this case, an angular interval α between the gates 7 adjacent to each other is 120°. That is, the thrust plate 1 manufactured by this manufacturing method has three gate marks on the inner circumferential face 5, in which these gate marks are formed at equal intervals in the circumferential direction. In this case, the gate marks are formed on the inner circumferential face 5 of the thrust plate 1 and do not interfere with sliding contact with the planetary gear or the carrier.

In the manufacturing method illustrated in FIG. 5, the number of the gates 7 is the same as the number of the grooves 2 on the one thrust face 1a and the grooves 3 on the other thrust face 1b, and the gates 7 are disposed on the inner circumferential face 5 on which the grooves 2 and the grooves 3 are not arranged in the circumferential direction. That is, the gates 7 are provided so as not to overlap with the grooves 2 and the grooves 3 in the circumferential direction. In addition, as illustrated in FIG. 5(a), the gates 7 are preferably provided at the circumferential center between the groove 2 and the groove 3 adjacent to each other. This configuration can avoid a weld, which is formed at an area in which the molten resin merges during molding, from being positioned at the part of the groove of the thrust plate 1, and a reduction in the strength of the thrust plate 1 can be prevented. The grooves 2 and the grooves 3 are formed simultaneously with the injection molding of both thrust faces, not by post-processing. The number of the grooves on each one thrust face is preferably the same as the number of the gates as illustrated in FIG. 5.

The manufacturing method according to the present invention is applied to a thrust plate having an outer diameter dimension of 70 mm or greater, and the number of the gates arranged is not limited to a particular number so long as it is three or more. However, as the outer diameter dimension of the thrust plate increases, the number of the gates is preferably increased. When the outer diameter dimension of the thrust plate is greater than 90 mm, for example, four or more gates are preferably provided.

Although in the example in FIG. 5 three or more gates are disposed on the inner circumferential face 5 of the thrust plate 1, the positions of the gates are not limited to this example. Three or more gates may be disposed on the outer circumferential face 6 of the thrust plate 1, for example. That is, three or more gates may be disposed on a cavity face corresponding to the outer circumferential face 6 of the thrust plate 1. In this case, the gate marks of the thrust plate 1 are formed on the outer circumferential face 6 and do not interfere with sliding contact with the planetary gear or the carrier. It should be noted that considering disadvantages in that the mold with a larger size can increase an injection molding machine used in size or increases the price of the mold, the gates are preferably formed for the inner circumferential face 5 rather than the outer circumferential face 6. In addition, by providing the gates for the inner circumferential face 5, the moving distance of the molten resin is shorter, and cooling difference in the molten resin to be charged is not likely to occur, thus having a good influence on the strain or warp on the planes.

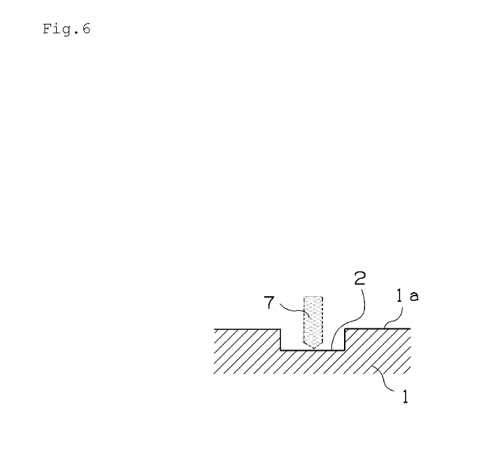

In the manufacture of the thrust plate having the grooves on the thrust face, the gates can be disposed on the thrust face. As illustrated in FIG. 6, for example, the gate 7 can be provided within the groove 2 of the thrust face 1a. That is, the gate 7 is disposed on a cavity face corresponding to the groove 2 as a recess, whereby gate marks (protrusions) after gate cutting can be prevented from protruding from the thrust face 1a. Consequently, the gate marks do not interfere with sliding contact with the planetary gear or the carrier. In this case, the gate is provided at the center of the groove length, whereby the moving distance of the molten resin is shorter, and cooling difference in the molten resin to be charged is not likely to occur, thus having a good influence on the strain or warp on the planes.

For the gate, any gate used for general injection molding can be employed without any particular limitation. A side gate, a pin gate, a submarine gate, a banana gate, and the like can be employed, for example. The side gate is preferred because a gate port can be increased in size, and an injection speed can be increased, thus having a good influence on the strain or warp on the planes. When a disc gate is used, the strain on the planes as the problem according to the present invention does not occur. However, the amount of the synthetic resin used is larger, and besides, another process to remove the disc gate is required, thus making a cost reduction difficult, and it is difficult to employ the disc gate.

The manufacturing method according to the present invention is not limited to applications to particular shapes of the thrust plate to be manufactured so long as it is a method that charges the synthetic resin using three or more gates provided at equal intervals in the circumferential direction to manufacture a hollow disc-shaped thrust plate having an outer diameter dimension of greater than 70 mm. Although FIG. 5 illustrates a thrust plate in which the radial grooves are formed from the inner circumference to the outer circumference of the disc on both thrust faces, the form of the grooves is not limited to this example. Grid-like grooves can be formed, for example.

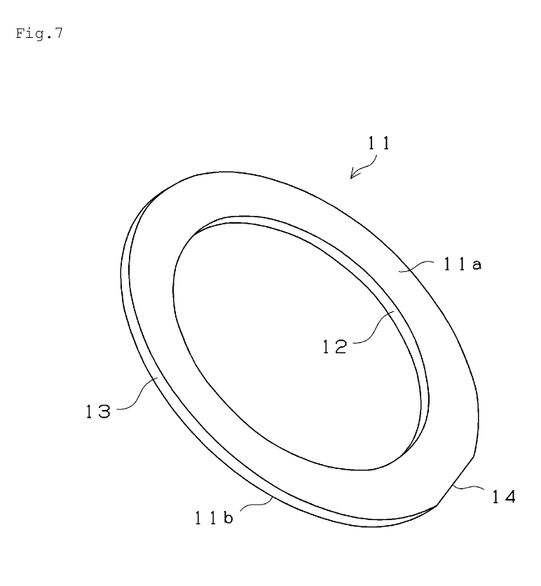

A thrust plate having no groove on the thrust faces thereof (refer to FIG. 7) can also be manufactured by the manufacturing method according to the present invention. As illustrated in FIG. 7, this thrust plate 11 is a hollow disc-shaped (an annular plate-shaped) member, in which a thrust face 11a and a thrust face 11b as the opposite face thereof have a plane shape. The thrust plate 11 has a detent 14 formed by cutting off part of the outer circumference of the disc. This detent 14 is engaged with part of a carrier (refer to FIG. 10), whereby the relative rotation of the thrust plate 11 with respect to the carrier can be prevented. Both thrust faces 11a and 11b of the thrust plate 11 are formed of flat faces without irregularities, and the thickness (the axial length) of the thrust plate 11 is formed to be uniformly equal. The thrust plate 11 has an inner circumferential face 12 connecting both thrust faces 11a and 11b together on its inner radial side and an outer circumferential face 13 connecting both thrust faces 11a and 11b together on its outer radial side. The axial length of the inner circumferential face 12 and the outer circumferential face 13 is 1 mm to 5 mm and corresponds to the thickness of the thrust plate 1.

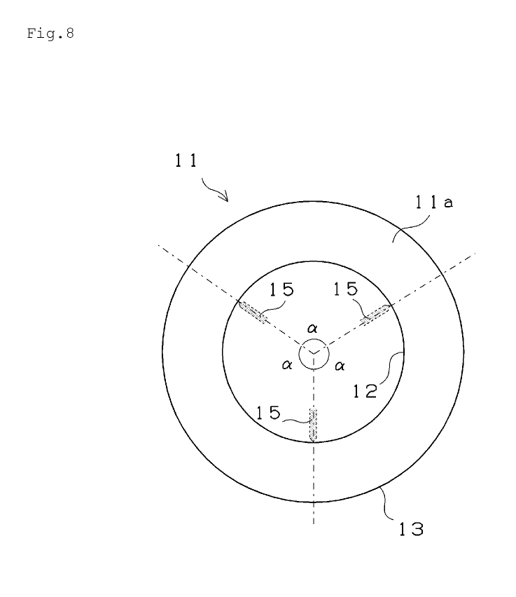

FIG. 8 is a schematic diagram of an example of a method for manufacturing the thrust plate in FIG. 7. In the example illustrated in FIG. 8, three gates 15 are individually disposed on the inner circumferential face 12 of the thrust plate 11. These three gates 15 are arranged at equal intervals (uniformly) in the circumferential direction. In this case, the angular interval α between the gates 15 adjacent to each other is 120°. That is, the thrust plate 11 manufactured by this manufacturing method has three gate marks on the inner circumferential face 12, in which these gate marks are formed at equal intervals in the circumferential direction. In this case, the gate marks are formed on the inner circumferential face 12 of the thrust plate 11 and do not interfere with sliding contact with the planetary gear or the carrier.

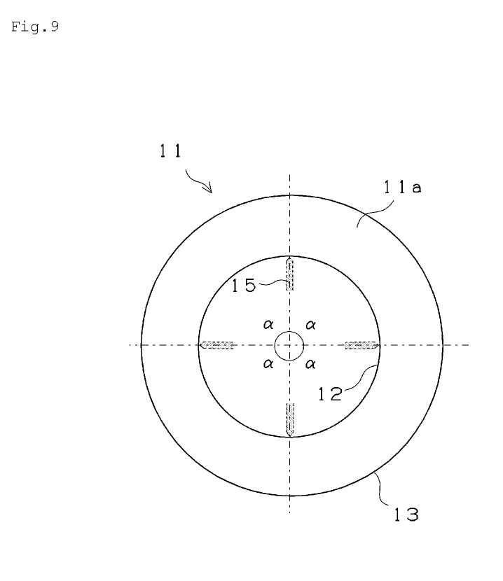

FIG. 9 is a schematic diagram of another example of the method for manufacturing the thrust plate in FIG. 7. In the example in FIG. 9, four gates 15 are individually disposed on a cavity face corresponding to the inner circumferential face 12 of the thrust plate 11. These four gates 15 are also arranged at equal intervals (uniformly) in the circumferential direction. In this case, the angular interval α between the gates 15 adjacent to each other is 90°.

As described above, the manufacturing method according to the present invention charges the molten resin through three or more gates provided at equal intervals in the circumferential direction and can thereby charge the synthetic resin uniformly and can reduce variations in the amount of the synthetic resin on the planes. With this effect, the strain on the planes is relaxed, and a usable state can be maintained even after being injection-molded. Consequently, the manufacturing method according to the present invention eliminates shape correction with a hot-plate press.

The thrust plate according to the present invention is manufactured in a certain shape by injection molding with the synthetic resin as a material. Both thrust faces of the thrust plate are finished by injection molding. Consequently, skin layers are formed on the surfaces of both thrust faces. The skin layers are rich in a resin component (high in a resin component proportion), thus make reinforcing members blended in the synthetic resin difficult to expose, and are difficult to attack an opposite member even when being blended with reinforcing members such as glass fibers. The grooves are formed simultaneously with the injection molding of both thrust faces, not by post-processing. In the manufacturing method according to the present invention, in injection molding, three or more gates are disposed on the thrust plate, and these gates are provided so as to have equal intervals in the circumferential direction. In the manufacture of the thrust plate having the grooves on the thrust face, the positions of the gates are preferably designed such that gate marks and a weld, which is formed at an area in which the molten resin merges during molding, are avoided from being positioned at the part of the groove of the thrust plate.

### INDUSTRIAL APPLICABILITY

The synthetic resin thrust plate according to the present invention can eliminate correction of the plane shape thereof with a hot-plate press and can thus be widely used as a low-cost thrust plate. The synthetic resin thrust plate according to the present invention can be used as a thrust plate interposed between a planetary gear and a carrier in a planetary gear device mainly used for construction machinery such as travel devices, swing devices, and rope winches for hydraulic cranes of hydraulic cranes and the like and can be suitably used as a thrust plate having an outer diameter of greater than 70 mm in particular.

### REFERENCE SIGNS LIST

1: synthetic resin thrust plate
2: groove (one thrust face)
3: groove (another thrust face)
4: detent
5: inner circumferential face
6: outer circumferential face
7: gate
8: mold
9: cavity
11: synthetic resin thrust plate
12: inner circumferential face
13: outer circumferential face
14: detent
15: gate
21: planetary gear device
22: sun gear
23: planetary gear
24: carrier
25: needle bearing
26: planetary gear shaft

1. A hollow disc-shaped, synthetic resin thrust plate, the thrust plate having a plurality of radial grooves at equiangular intervals in terms of a disc central angle on each of both thrust faces,
wherein the grooves on one thrust face and the grooves on another thrust face are same in number, and
the grooves on the one thrust face and the grooves on the other thrust face are arranged so as not to overlap with each other in a circumferential direction.

2. The synthetic resin thrust plate according to claim 1, wherein the grooves on the one thrust face and the grooves on the other thrust face are arranged so as to have an angular deviation of ½ of an angular interval between the grooves adjacent to each other on a same thrust face in terms of the disc central angle.

3. The synthetic resin thrust plate according to claim 1, wherein the thrust plate is an injection-molded product and has skin layers by injection molding on both thrust faces.

4. The synthetic resin thrust plate according to claim 1, wherein the synthetic resin is at least one selected from polyamide resin, polyacetal resin, polyphenylene sulfide resin, polyether ether ketone resin, and polyimide resin.

5. The synthetic resin thrust plate according to claim 1, wherein the thrust plate has a thickness of 1 mm to 5 mm and an outer diameter of greater than 70 mm.

6. The synthetic resin thrust plate according to claim 1, wherein the thrust plate is used for a planetary gear device, is arranged between a planetary gear and a carrier included in the device such that the one thrust face is in contact with the planetary gear and the other thrust face is in contact with the carrier, and has a hollow part into which a planetary gear shaft inserted when used.

7. The synthetic resin thrust plate according to claim 6, wherein the planetary gear device is a planetary gear device used for construction machinery.

8. A method for manufacturing the synthetic resin thrust plate as claimed in claim 1 by injection molding, wherein
the thrust plate has a thickness of 1 mm to 5 mm and an outer diameter of greater than 70 mm; and
three or more gates in the injection molding are disposed on the thrust plate at equal intervals in a circumferential direction of the thrust plate, and the synthetic resin is charged through the gates.

9. The method for manufacturing the synthetic resin thrust plate according to claim 8, wherein the gates are disposed on an inner circumferential face of the thrust plate.

10. The method for manufacturing the synthetic resin thrust plate according to claim 8, wherein
a number of the gates is same as the number of the grooves on the one thrust face and the number of the grooves on the other thrust face; and
the gates are provided so as not to overlap with the grooves on the one thrust face and the grooves on the other thrust face in the circumferential direction.
